(19) United States
(12) Patent Application Publication
(10) Pub. No.: US 2010/0330288 A1
(43) Pub. Date: Dec. 30, 2010

(54) METHODS FOR RECLAMATION OF INORGANIC FILLER FROM WASTE CARPET AND CARPET MANUFACTURED FROM SAME

(76) Inventors: Jeffery Segars, Cartersville, GA (US); Jeffrey J. Wright, Cartersville, GA (US); James Jarrett, Cartersville, GA (US)

Correspondence Address: Ballard Spahr LLP, SUITE 1000, 999 PEACHTREE STREET, ATLANTA, GA, 30309-3915, US

(21) Appl. No.: 12/776,844

(22) Filed: May 10, 2010

Related U.S. Application Data
(60) Provisional application No. 61/176,774, filed on May 8, 2009.

(51) Int. Cl. C01F 11/18; B05D 1/36; C09C 1/36; C09C 1/04; C09C 1/02; C09C 1/28

(52) U.S. Cl. 427/407.1; 423/430; 106/405; 106/449; 106/425; 106/455; 106/464; 106/465

(57) ABSTRACT

Disclosed are methods for reclaiming inorganic material from waste carpeting. The method comprises providing a waste carpeting composition comprising an inorganic filler component and an organic component. The waste carpeting is heat treated under conditions effective to separate at least a portion of the organic component from the waste carpeting composition and to provide a reclaimed inorganic filler composition at least substantially free of the organic component. Also disclosed are carpets comprising the reclaimed inorganic material reclaimed by the methods disclosed herein.

### CROSS-REFERENCE TO RELATED APPLICATIONS

This application claims the benefit of priority to U.S. Provisional Patent Application 61/176,774 filed May 8, 2009, the entire contents of which are incorporated by reference herein for all purposes.

### FIELD OF THE INVENTION

The present invention relates generally to methods and systems for reclaiming one or more inorganic components from a waste carpet. The invention also relates to carpet comprising a waste carpet material reclaimed by the methods and systems disclosed. Still further, the invention also relates to methods for the manufacture of carpet comprising a material reclaimed from a waste carpet.

### BACKGROUND OF THE INVENTION

Carpet is a common floor covering used in many businesses and residences. While well-made carpet is generally versatile and long-lasting, carpet waste nonetheless represents a growing concern in both private industry and governments. Carpet waste can include, for example, post consumer carpet, including commercial, industrial and residential waste carpet; manufacturing remnants; quality control failures, and the like. Waste carpet can be used carpet, e.g., carpet removed from an apartment complex, or unused carpet, e.g., residual carpet left from an installation or manufacturing process.

Unfortunately, carpet waste is generally landfilled. While most estimates indicate that carpet waste constitutes only 1 to 2% of all municipal solid waste, this amount still represents a vast quantity of waste that can have a substantial economic and environmental impact. As a result, many in the industry have turned to carpet recycling as a solution to carpet waste. Recycling carpet, however, is difficult because its major components are chemically and physically diverse. Most carpets comprise about 20-50 weight percent face fiber, the remainder being backing materials, commonly polypropylene, and an adhesive which attaches the carpet fiber to the backing material. The adhesive typically comprises a carboxylated styrene-butadiene (XSB) latex copolymer, and inorganic filler like calcium carbonate.

Most carpet recycling methods to date have focused on recycling certain environmentally malignant constituents of carpet. Examples include polymers, such as nylon, and adhesive constituents found in waste carpet. However, little attention has been devoted to the various other constituents of carpet, such as inorganic filler. While such constituents may not present a direct environmental harm, they nonetheless represent a potential cost savings and a reduction in landfilling burden. If such materials could be reclaimed and recycled, the supply of such materials could be augmented, thereby reducing the burden to manufacture new materials. In addition, such broad-based recycling methods can also potentially help to comport with National Sanitation Foundation (NSF) 140/2007 recommendations, which encourage carpet industries to develop sustainable carpet manufacturing and recycling programs for social, economic, and environmental benefits.

Accordingly, there is a need to provide improved methods and systems for recycling one or more component parts of carpet. Further, there is a need to provide improved carpet recycling methods and systems that can yield reclaimed materials suitable for use in the manufacture of new carpets and like materials. Still further, there is a need for the manufacture of carpet structures comprising one or more materials that have been reclaimed from a post consumer carpet. These needs and other needs are at least partially satisfied by the present invention.

### SUMMARY OF THE INVENTION

The present invention provides a method for reclaiming one or more inorganic components from waste carpet. The waste carpet can be any carpet, including latex coated carpet. In one aspect, the carpet can be a post consumer carpet, post commercial carpet, post industrial carpet, manufacturing remnants, quality control failures, and the like. In a further aspect, the carpet can comprise a waste carpet that would otherwise be discarded or landfilled by a consumer, distributor, retailer, installer, and the like. The method generally comprises providing a waste carpeting composition comprising an inorganic filler component and an organic component; and heat treating the waste carpeting composition under conditions effective to separate at least a portion of the organic component from the waste carpeting composition and to provide a reclaimed inorganic filler composition at least substantially free of the organic component. Also disclosed are the reclaimed inorganic filler compositions produced by the disclosed processes.

In other embodiments, methods are provided for manufacturing carpet using the reclaimed inorganic filler compositions. In one aspect, the method comprises mixing at least a portion of the reclaimed inorganic filler composition with a thermoplastic or thermoset composition to form a first carpet backing composition; and applying the first carpet backing composition to a bottom surface of a greige good comprised of a primary backing and a plurality of carpet fibers, wherein the plurality of carpet fibers penetrate a bottom surface of the primary backing and protrude therefrom a top surface of the primary backing.

Additional embodiments of the invention will be set forth, in part, in the detailed description, figures, and claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE FIGURES

FIG. 1 is a schematic representation of an exemplary method for reclaiming an inorganic filler composition from a waste carpeting composition.

FIG. 2 is a schematic representation of an exemplary method for manufacturing carpet comprising the use of a reclaimed inorganic filler composition.

FIG. 3 is an illustration of an exemplary tufted carpet.

FIG. 4 is a schematic representation of an exemplary extrusion coating line according to one aspect of the invention.

FIG. 5 is a schematic representation of an exemplary extrusion coating line according to an aspect of the invention.

FIG. 6 is a schematic representation of an exemplary tufted carpet tile according to one aspect of the invention.

### DETAILED DESCRIPTION OF THE INVENTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a “surface” includes aspects having two or more such surfaces unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The term “intimate contact” refers to the mechanical interaction between the bottom surface of the primary backing material and the first backing material (e.g., the adhesive backing material).

The term “substantial encapsulation” refers to the first backing material (e.g., the adhesive backing material) significantly surrounding the yarn or fiber bundles at or in immediate proximity to the interface between the back surface of the primary backing material and the adhesive backing material.

The term “substantial consolidation” refers to the overall integrity and dimensional stability of the carpet that is achieved by substantially encapsulating the yarn or fiber bundles and intimately contacting the back surface of the primary backing material with the adhesive backing material. In one aspect, a substantially consolidated carpet possesses good component cohesiveness and good delamination resistance with respect to the various carpet components.

The term “integral fusing” is used herein in the same sense as known in the art and refers to heat bonding of carpet components using a temperature above the melting point of the adhesive backing material. In this aspect, integral fusing occurs when the adhesive backing material comprises the same polymer as either the fibers or primary backing material or both. However, integral fusing does not occur when the adhesive backing material comprises a different polymer than the fibers and primary backing material. In a further aspect, by the term “same polymer,” it is meant that the monomer units of the polymers are of the same chemistry, although their molecular or morphological attributes may differ. Conversely, by the term “different polymer,” it is meant that, irrespective of any molecular or morphological differences, the monomer units of the polymers are of different chemistries. Thus, in accordance with the various definitions of the present invention, a polypropylene primary backing material and a polyethylene adhesive backing material would not integrally fuse because these carpet components are of different chemistries.

The term “carpet component” is used herein to refer separately to carpet fiber bundles, a primary backing material, an optional pre-coat layer, an adhesive backing material, an optional reinforcing layer, and an optional secondary backing material.

The term “extrusion coating” is used herein in its conventional sense to refer to an extrusion technique wherein a polymer composition usually in pellet-form is heated in an extruder to a temperature elevated above its melt temperature and then forced through a slot die to form a semi-molten or molten polymer sheet. The semi-molten or molten polymer sheet is continuously drawn down onto a continuously fed greige good to coat the backside of the greige good with the polymer composition. It should also be understood that, as used herein, extrusion coating is not limited to applying a coating to greige good but, rather, can be used to apply a composition to any desired component of a carpet construction, including for example, primary backing and/or secondary backing.

In one aspect, the term “lamination technique” is used herein in its conventional sense refer to applying adhesive backing materials to greige goods by first forming the adhesive backing material as a solidified or substantially solidified film or sheet and thereafter, in a separate processing step, reheating or elevating the temperature of the film or sheet before applying it to the back surface of the primary backing material.

The term “heat content” is used herein to refer to the mathematical product of the heat capacity and specific gravity of a filler. Fillers characterized as having high heat content are used in specific embodiments of the present invention to extend the solidification or molten time of adhesive backing materials. The Handbook for Chemical Technicians, Howard J. Strauss and Milton Kaufmann, McGraw Hill Book Company, 1976, Sections 14 and 2-1, the disclosure of which is incorporated herein by reference, provides information on the heat capacity and specific gravity of select mineral fillers. The fillers suitable for use in the present invention do not change their physical state (i.e., remain a solid material) over the extrusion coating processing temperature ranges of the present invention. Exemplary preferred high heat content fillers possess a combination of a high specific gravity and a high heat capacity.

The term “implosion agent” is used herein to refer to the use of conventional blowing agents or other compounds which out-gas or cause out-gassing when activated by heat, usually at some particular activation temperature. In the present invention, implosion agents can be used to implode or force adhesive backing material into the free space of yarn or fiber bundles.

The term “processing material” is used herein to refer to substances such as spin finishing waxes, equipment oils, sizing agents and the like, which can interfere with the adhesive or physical interfacial interactions of adhesive backing materials. Optionally, at least some of the processing materials can be removed or displaced by a scouring or washing technique of the present invention whereby improved mechanical bonding is accomplished.

The terms “polypropylene carpet” and “polypropylene greige goods” are used herein to mean a carpet or greige goods substantially comprised of polypropylene fibers, irrespective of whether the primary backing material for the carpet or greige good is comprised of polypropylene or some other material.

The terms “nylon carpet” and “nylon greige goods” are used herein to mean a carpet or greige goods substantially comprised of nylon fibers, irrespective of whether the primary backing material for the carpet or greige good is comprised of nylon or some other material.

The term “linear” as used to describe ethylene polymers is used herein to mean the polymer backbone of the ethylene polymer lacks measurable or demonstrable long chain branches, e.g., the polymer is substituted with an average of less than 0.01 long branch/1000 carbons.

As used herein, the term “copolymer” refers to a polymer formed from two or more different repeating units (monomer residues). By way of example and without limitation, a copolymer can be an alternating copolymer, a random copolymer, a block copolymer, or a graft copolymer.

The term “homogeneous ethylene polymer” as used to describe ethylene polymers is used in the conventional sense in accordance with the original disclosure by Elston in U.S. Pat. No. 3,645,992, the disclosure of which is incorporated herein by reference, to refer to an ethylene polymer in which the co-monomer is randomly distributed within a given polymer molecule and wherein substantially all of the polymer molecules have substantially the same ethylene to co-monomer molar ratio. As defined herein, both substantially linear ethylene polymers and homogeneously branched linear ethylene are homogeneous ethylene polymers.

Homogeneously branched ethylene polymers are homogeneous ethylene polymers that possess short chain branches and that are characterized by a relatively high short chain branching distribution index (SCBDI) or relatively high composition distribution branching index (CDBI). That is, the ethylene polymer has a SCBDI or CDBI greater than or equal to 50 percent, preferably greater than or equal to 70 percent, more preferably greater than or equal to 90 percent and essentially lack a measurable high density (crystalline) polymer fraction.

The SCBDI or CDBI is defined as the weight percent of the polymer molecules having a co-monomer content within 50 percent of the median total molar co-monomer content and represents a comparison of the co-monomer distribution in the polymer to the co-monomer distribution expected for a Bernoullian distribution. The SCBDI or CDBI of polyolefins can be conveniently calculated from data obtained from techniques known in the art, such as, for example, temperature rising elution fractionation (abbreviated herein as “TREF”) as described, for example, by Wild et al., Journal of Polymer Science, Poly. Phys. Ed., Vol. 20, p. 441 (1982), L. D. Cady, “The Role of Comonomer Type and Distribution in LLDPE Product Performance,” SPE Regional Technical Conference, Quaker Square Hilton, Akron, Ohio, October 1-2, pp. 107-119 (1985), or in U.S. Pat. Nos. 4,798,081 and 5,008,204, the disclosures of all of which are incorporated herein by reference. However, the preferred TREF technique does not include purge quantities in SCBDI or CDBI calculations. More preferably, the co-monomer distribution of the polymer and SCBDI or CDBI is determined using 13C NMR analysis in accordance with techniques described, for example, in U.S. Pat. No. 5,292,845 and by J. C. Randall in Rev. Macromol. Chem. Phys., C29, pp. 201-317, the disclosures of which are incorporated herein by reference.

The terms “homogeneously branched linear ethylene polymer” and “homogeneously branched linear ethylene/α-olefin polymer” means that the olefin polymer has a homogeneous or narrow short branching distribution (i.e., the polymer has a relatively high SCBDI or CDBI) but does not have long chain branching. That is, the linear ethylene polymer is a homogeneous ethylene polymer characterized by an absence of long chain branching. Such polymers can be made using polymerization processes (e.g., as described by Elston in U.S. Pat. No. 3,645,992) which provide a uniform short chain branching distribution (i.e., homogeneously branched). In his polymerization process, Elston uses soluble vanadium catalyst systems to make such polymers, however others, such as Mitsui Petrochemical Industries and Exxon Chemical Company, have reportedly used so-called single site catalyst systems to make polymers having a homogeneous structure similar to polymer described by Elston. Further, U.S. Pat. No. 4,937,299 to Ewen et al. and U.S. Pat. No. 5,218,071 to Tsutsui et al., the disclosures of which are incorporated herein by reference, disclose the use of metallocene catalysts for the preparation of homogeneously branched linear ethylene polymers. Homogeneously branched linear ethylene polymers are typically characterized as having a molecular weight distribution, Mw/Mn, of less than 3, preferably less than 2.8, more preferably less than 2.3.

The terms “homogeneous linearly branched ethylene polymer” or “homogeneously branched linear ethylene/α-olefin polymer” do not refer to high pressure branched polyethylene which is known to those skilled in the art to have numerous long chain branches. In one aspect, the term “homogeneous linear ethylene polymer” generically refers to both linear ethylene homopolymers and to linear ethylene/α-olefin interpolymers. For example, a linear ethylene/α-olefin interpolymer possess short chain branching and n the α-olefin is typically at least one C3-C20 α-olefin (e.g., propylene, 1-butene, 1-pentene, 4-methyl-1-pentene, 1-hexene, and 1-octene).

References in the specification and concluding claims to parts by weight of a particular element or component in a composition or article, denotes the weight relationship between the element or component and any other elements or components in the composition or article for which a part by weight is expressed. Thus, in a composition or a selected portion of a composition containing 2 parts by weight of component X and 5 parts by weight component Y, X and Y are present at a weight ratio of 2:5, and are present in such ratio regardless of whether additional components are contained in the composition.

A weight percent of a component, unless specifically stated to the contrary, is based on the total weight of the formulation or composition in which the component is included.

As used herein, and unless the context clearly indicates otherwise, the term carpet is used to generically include broadloom carpet, carpet tiles, and even area rugs. To that “broadloom carpet” means a broadloom textile flooring product manufactured for and intended to be used in roll form. “Carpet tile” denotes a modular floor covering, conventionally in 18″×18,″ 24″×24″ or 36″×36″ squares, but other sizes and shapes are also within the scope of the present invention.

The present invention may be understood more readily by reference to the following detailed description of preferred embodiments of the invention and the examples included therein and to the Figures and their previous and following description.

As summarized above, in one broad aspect, the present invention provides a carpet recycling system and method for reclaiming one or more inorganic components from a manufactured carpet structure, such as a waste carpet.

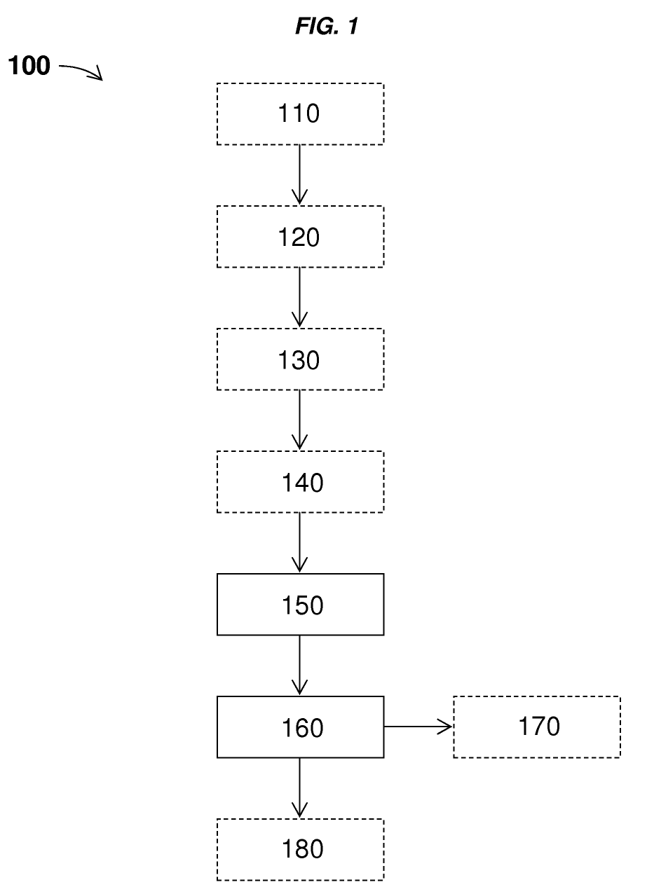

FIG. 1 schematically illustrates an exemplary recycling method and system 100 according to one aspect of the present invention. As shown, a waste carpet composition 150 is provided. It is contemplated that the waste carpet composition can be derived from any carpet. In one aspect, and without limitation, the carpet can be a post consumer carpet, including post commericial, post industrial, and post residential waste; manufacturing remnants; quality control failures; and the like. In a further aspect, the carpet can comprise a waste carpet that would otherwise be discarded or landfilled by a consumer, distributor, retailer, installer, and the like.

The waste carpet composition can be derived from any desired carpet structure, including without limitation, tufted carpet, needle-punched carpet, and even hand woven carpet. Additionally, the system and method can be used in connection with broadloom carpets, carpet tiles, and even area rugs, so long as the carpet structure comprises at least one inorganic component desired for reclamation. In one aspect, the waste carpet structure comprises fiber bundles, a primary backing material, an optional pre-coat layer, an adhesive backing material, an optional reinforcing layer, and an optional secondary backing material.

A waste carpet composition can be provided by commercial sources or by methods disclosed herein, among other methods known in the art. A variety of commercial sources offer mechanically shredded industrial carpet wastes which can be incorporated into a disclosed method. Another such source of waste carpet material is known as Co-Product (Residue from Carpet Recycling Process) manufactured by Shaw Industries Evergreen Nylon Recycling LLC, a joint venture of DSM and Honeywell in Augusta, Ga. in which the waste carpet material includes calcium carbonate 50-70%, a thermoplastic resin mixture 0-45%, nylon 0-45% and caprolactam 0-8%, all percentages being by weight. The waste carpet material can also include latex.

In a further aspect, a waste carpet composition suitable with the methods disclosed herein can be provided by processing waste carpets. Various processing steps can be employed, depending on the carpet, including, without limitation, removing extraneous materials, size reduction, removal of recyclable components, among other steps.

In one aspect, the waste carpet comprises post consumer carpet. An example of post consumer carpet is post residential carpet. As is commonly found in connection with post consumer carpet, extraneous materials that can be detrimental to the efficiency of the recycling process may be present in the post consumer carpet. Exemplary extraneous materials can include metallic materials such as staples, metal strips, nails, brads, or even tools that were used during the removal of the carpet from the location of its initial installation. Accordingly, the system and method can optionally comprise step 110 wherein any extraneous materials are first removed from the post consumer carpet. Once the extraneous materials are removed (if at all) the post consumer carpet can then be sent to a size reduction station 120.

Size reduction can be effected by various types of conventional, commercially available, size reduction equipment such as guillotines, rotary cutters, shear shredders, open rotor granulators, closed rotor grinders, and rotor shredding machines. The exact configuration of the primary size reduction equipment is not critical, so long as the size reduction operation does not produce a substantial amount of fine face fiber particles that can be lost in later operations to thus preclude their recovery. In one aspect, shredding can be used to grind a waste carpet. A rotor shredding machine is especially suited for a feedstock composed of whole carpet waste material. This apparatus permits direct feeding of bales of carpet, and the carpet waste material can be size reduced without the need for additional size reduction apparatus. In one aspect, preferred size reduction equipment includes a Herbold Type SMS 60/100/G3/2 granulator. While any desired size reduction can also be used, in a preferred aspect the carpet is reduced to a plurality of chunks or pieces having an average length and/or width in the range of from 0.5 inches up to 4 inches.

Once the feedstock carpet has been reduced to appropriately sized pieces, the feedstock can optionally be pre-washed in a washing station 130 to remove any impurities such as dirt, sand, oil, inorganic waste, or organic waste that may be present in the post consumer carpet. The optional pre-wash of the sized reduced carpet pieces can comprises a solvent wash utilizing, for example, water, acetone, or even an organic solvent.

In one aspect, a waste carpet composition can comprise other materials, such as recyclable materials which can optionally be removed 140 prior to further processing. Such materials can include a thermoplastic organic composition, a thermoset organic composition, or another thermoresponsive organic composition. Specific examples of recyclable materials include, without limitation, nylon 6, nylon 6,6, polyethylene terephthalate (PET), polytrimethylene terephthalate, polypropylene, polyester, or a combination thereof. Such recyclable materials can be removed 150 from the composition prior to further processing and optionally recycled. For example, the nylon can be depolymerized through, for example, ammonolysis, and the monomer can be removed from the composition prior to further processing, according to conventional methods known to those of ordinary skill in the art. In one aspect, nylon 6 is present, and the nylon 6 is depolymerized to caprolactam, which is subsequently recovered prior to further processing.

The waste carpet composition provided 150 can include an inorganic filler component. The inorganic filler component can comprise, inter alia, calcium carbonate, calcium sulfate, calcium silicate, magnesium carbonate, magnesium oxide, magnesium hydroxide aluminum trihydrate, alumina, hydrated alumina, aluminum silicate, barium sulfate, barite, flyash, glass cullet, glass fiber and powder, metal powder, clay, silica or glass, fumed silica, talc, carbon black or graphite, fly ash, cement dust, feldspar, nepheline, zinc oxide, titanium dioxide, titanates, glass microspheres, chalk, and mixtures thereof. Among these, preferred fillers comprise calcium carbonate, barium sulfate, talc, silica/glass, alumina, and titanium dioxide, and mixtures thereof. More preferable fillers comprises calcium carbonate.

Likewise, the filler can be ignition resistant. Exemplary ignition resistant fillers can comprise antimony oxide, decabromobiphenyl oxide, alumina trihydrate, magnesium hydroxide, borates, and halogenated compounds. Of these ignition resistant fillers, those that comprise alumina trihydrate and magnesium hydroxide are preferred.

Referring back to FIG. 1, once the waste carpeting composition is provided, the composition can be heat treated 160 under conditions effective to separate at least a portion of the organic component from the waste carpeting composition and to provide a reclaimed inorganic filler composition at least substantially free of the organic component.

In one aspect, the heat treatment step 160 can be accomplished through the use of a rotary kiln. According to this aspect, the waste carpeting composition can be conveyed to a rotary kiln to be accurately fed into the kiln using a weigh-belt feeder. The carpeting composition can then optionally be combined with filler that acts as a dusting powder and prevents the carpeting material from sticking together in the kiln. The carpeting composition and dusting powder can then be accurately fed into the kiln. Once the composition and dusting powder are inside the kiln, the heat treatment step converts substantially all of the organic material contained in the composition to syngas which then exists through the kiln entrance into a dust chamber. In one aspect, the heat treatment step 160 can be carried out at a temperature in the range of from about 400° C. to about 825° C., including, for example, 450° C., 500° C., 550° C., 600° C., 650° C., 700° C., 750° C., and 800° C. Still further, the heat treatment step can be carried out at any temperature within a range of temperatures derived from the above values. For example, the heat treatment can be carried out at a temperature in the range of from 450° C. to about 800° C., 500° C. to about 750° C., or even 550° C. to about 750° C. Once the organic material is removed, the inorganic portion can be conveyed to the exit of the kiln. The inorganic material can then be ground and classified. Optionally, the syngas produced during the heat treatment step can be routed into a combustion chamber and ignited.

If calcium carbonate is present in the waste carpeting composition, calcium oxide can be generated during the heat treatment step. It will be apparent that calcium oxide has a propensity to form at higher temperatures, especially those temperatures above 825° C. It should be appreciated that the presence of calcium oxide is not be desirable in some aspects. For example, in a water based system, calcium oxide can react with water to form calcium hydroxide, a basic substance that is not beneficial in certain water-based systems. However, even if calcium oxide forms during the heat treatment step, carbon dioxide (CO₂) gas can be applied to the reclaimed calcium carbonate mixture to convert the calcium oxide back to calcium carbonate.

In one aspect, the heat treatment step can generate thermal energy that can be used 170 in the current process, other processes, or, in the alternative, the energy can be stored for later use, for example, by converting the thermal energy to electrical energy and storing the electrical energy in a battery. It will be apparent that the heat content of the waste carpeting composition can vary depending on the components and degree of processing of the waste carpet. In one aspect, heat content is at least about 2400 BTU per pound, at least about 4000 BTU per pound, or at least about 5000 BTU per pound. It should be appreciated that, in one aspect, heat content will decrease as backing fiber is removed from a waste carpet.

In one aspect, the heat treatment step can be effective at separating at least a portion of the organic component from the waste carpeting composition. The amount of organic material removed from the composition can vary depending on the temperature used and the duration of the heat treatment. In one aspect, the step of heat treatment is effective to remove at least about 95-99.9% of the organic component from the waste carpeting composition. To this end, the phrase substantially free of the organic component can include embodiments where at least 95 weight percent, at least 98 weight percent, at least 99 weight percent, at even least 99.9 weight percent of the organic component has been removed. The removal or absence of the organic component can be evaluated by analysis of V.O.C. content or volatile organic compound content of the remaining inorganic filler composition.

Again with reference to FIG. 1, in a further aspect, once at least a portion of the organic component is separated from the waste carpeting composition, the inorganic filler composition can be reclaimed. The reclaimed inorganic filler composition can be further processed 180 if desired. As noted above, for example, if calcium oxide is present, the calcium oxide can be converted back to calcium carbonate. Further processing steps can include size reducing the reclaimed inorganic filler composition to provide an inorganic filler having one or more predetermined particle size distribution characteristics.

The reclaimed inorganic filler can be provided in particulate form, either before or after the optional size reduction referred to above. Particulate forms of the reclaimed inorganic material can have any desired particle size distribution characteristics. For example, in one aspect, the particle size distribution characteristics can be selected to replicate particle size distribution characteristics of a conventional virgin inorganic filler material. Exemplary particle size distribution characteristics to be replicated can include predetermined values of D₍ₙ₎, where (n) represents a mass percentage such as 5%, 10%, 15%, 20%, 25%, 30%, 35%, 40%, 45%, 50%, 55%, 60%, 65%, 70%, 75%, 80%, 85%, 90%, 95%, or 100%. The value of D₍ₙ₎ thus represents the particle size of which (n) percentage of the mass is finer than. For example, the quantity D₍₁₀₀₎ represents the particle size of which 100% of a mass is finer than. The quantity D₍₇₅₎ represents the particle size of which 75% of a mass is finer than. The quantity D₍₅₀₎ is the median particle size of a mass for which 50% of the mass is finer than. The quantity D₍₂₅₎ represents the particle size of which 25% of a mass is finer than. The quantity D₍₁₀₎ represents the particle size of which 10% of a mass is finer than.

In exemplary and non-limiting embodiments, the value of D₍₁₀₀₎ can be less than 70 μm, 65 μm, 60 μm, 55 μm, 50 μm, or 45 μm. D₍₁₀₀₎ can also be greater than 40 μm, 45 μm, 50 μm, 55 μm, 60 μm, or 65 μm. Still further, D₍₁₀₀₎ can be a value within a range of any two D₍₁₀₀₎ values provided above. Exemplary values for D₍₇₅₎ can be less than 70 μm, 65 μm, 60 μm, 55 μm, 50 μm, 45 μm, 40 μm, 35 μm, 30 μm, 25 μm, or 20 μm. D₍₇₅₎ can also be greater than 20 μm, 25 μm, 30 μm, 35 μm, 40 μm, 45 μm, 50 μm, 55 μm, 60 μm, or 65 μm. Still further, D₍₇₅₎ can be a value within a range of any two D₍₇₅₎ values provided above. Exemplary values for D₍₅₀₎ can be less than 20 μm, 18 μm, 15 μm, 13 μm, 10 μm, or even 8 μm. Alternatively, exemplary values for D₍₅₀₎ can also be greater than 8 μm, 10 μm, 13 μm, 15 μm, 18 μm, or even 20 μm. Still further, D₍₅₀₎ can be a value within a range of any two D₍₅₀₎ values provided above. Exemplary values for D₍₂₅₎ can be less than 10 μm, 8 μm, 5 μm, 3 μm, or even 1 μm. Alternatively, exemplary values for D₍₂₅₎ can also be greater than 1 μm, 3 μm, 5 μm, 8 μm, or even 10 μm. Still further, D₍₂₅₎ can be a value within a range of any two D₍₂₅₎ values provided above. Exemplary values for D₍₁₀₎ can be less than 2 μm, 1.5 μm, 1 μm, or even 0.5 μm. Alternatively, exemplary values for D₍₁₀₎ can also be greater than 0.5 μm, 1 μm, 1.5 μm, or even 2 μm. Still further, D₍₁₀₎ can be a value within a range of any two D₍₁₀₎ values provided above.

In an alternative aspect, the particle size distribution of the reclaimed inorganic filler material can be characterized by conventional wet screen test methods. For example, in one aspect, the reclaimed inorganic filler material can comprise a particle size distribution that, when characterized utilizing a 200 mesh screen, results in 15 weight % or less of the starting mass of particulate material being retained by the 200 mesh screen. A 200 mesh screen will retain particles having diameters larger than 74 microns and thus, according to this aspect, 15 weight % or less of the reclaimed inorganic filler is comprised of particles sizes larger than 74 microns. In another aspect, the reclaimed inorganic filler material can comprise a particle size distribution that, when characterized utilizing a 325 mesh screen, results in 30 weight % or less of the starting mass of particulate material being retained by the 325 mesh screen. A 325 mesh screen will retain particles having diameters larger than 44 microns and thus, according to this aspect, 30 weight % or less of the reclaimed inorganic filler is comprised of particles sizes larger than 44 microns. In still another aspect, the reclaimed inorganic material exhibits both the 15 weight % 200 mesh and 30 weight % 325 mesh characteristics described above.

In one aspect, the reclaimed inorganic filler composition can comprise residual organic matter not recycled and/or not removed during the heat treatment step. The residual organic matter can include, for example, any one or more of those organic materials discussed above.

In one aspect, the reclaimed inorganic filler composition can be reused in another material or process. For example, materials other than carpeting materials that typically use calcium carbonate as an inorganic filler include, without limitation, roofing materials, road paving materials, awnings, and tarps.

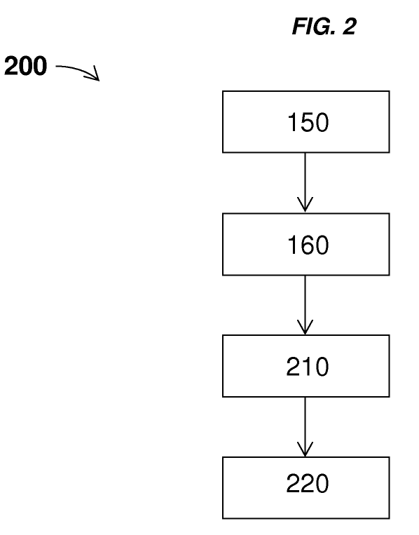

Also provided is a method for manufacturing carpet comprising the use of the reclaimed inorganic filler composition obtained by the methods described above. The reclaimed inorganic filler composition can be used in the manufacture of one or more components of a carpet composition. With reference to FIG. 2, in one aspect, a method for manufacturing carpet 200 comprises providing a waste carpeting composition 150, as discussed above. The waste carpeting composition can then be heat treated 160, thereby providing the inorganic filler composition. At least a portion of the inorganic filler composition can then be mixed with a thermoresponsive composition, including a thermoplastic and/or a thermoset, to form 210 a first carpet backing composition. The first backing composition can be applied 220 to a bottom surface of a greige good comprised of a primary backing and a plurality of carpet fibers, wherein the plurality of carpet fibers penetrate a bottom surface of the primary backing and protrude therefrom a top surface of the primary backing.

In general, it is contemplated that the method for manufacturing carpet can be applied to any carpet, including, inter alia, tufted carpets, needle-punched carpets, hand woven carpets, broadloom carpets, carpet tiles, and even area rugs.

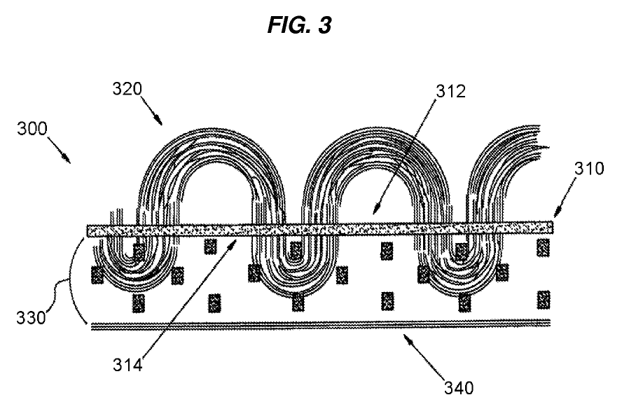

In one aspect, the carpet can be a tufted broadloom carpet. In an alternative aspect, the carpet can be a tufted carpet tile. As illustrated in FIG. 3, an exemplary tufted carpet 300 is shown. The tufted carpet 300 is a composite structure which includes yarn 320 (which is also known as a fiber bundle), a primary backing material 310 having a face surface 312 and a back surface 314, an adhesive backing material 330 and, optionally, a secondary backing material 340. To form the face surface of tufted carpet, the yarn is tufted through the primary backing material such that the longer length of each stitch extends through the face surface of the primary backing material.

The face of a tufted carpet can generally be made in three ways. First, for loop pile carpet, the yarn loops formed in the tufting process are left intact. Second, for cut pile carpet, the yam loops are cut, either during tufting or after, to produce a pile of single yarn ends instead of loops. Third, some carpet styles include both loop and cut pile. One variety of this hybrid is referred to as tip-sheared carpet where loops of differing lengths are tufted followed by shearing the carpet at a height so as to produce a mix of uncut, partially cut, and completely cut loops. Alternatively, the tufting machine can be configured so as to cut only some of the loops, thereby leaving a pattern of cut and uncut loops. Whether loop, cut, or a hybrid, the yarn on the back side of the primary backing material comprises tight, unextended loops.

The combination of tufted yarn and a primary backing material without the application of an adhesive backing material or secondary backing material is referred to in the carpet industry as raw tufted carpet or greige goods. Greige goods become finished tufted carpet with the application of an adhesive backing material and an optional secondary backing material to the back side of the primary backing material. Finished tufted carpet can be prepared as broad-loomed carpet in rolls typically 6 or 12 feet wide. Alternatively, carpet can be prepared as carpet tiles, which are, for example and without limitation, 18 inches square, 24 inches square, 36 inches square, 50 cm, and 60 cm square.

In one aspect, the first backing composition is an adhesive composition. The adhesive backing composition is applied to the back face of the primary backing material to affix the yarn to the primary backing material. In one aspect, the adhesive backing substantially encapsulates a portion of the back stitching of the yarn, penetrates the yarn, and binds individual carpet fibers. Properly applied adhesive backing materials do not substantially pass through the primary backing material.

In a further aspect, the first carpet backing composition comprises at least a portion of the reclaimed inorganic filler composition. As discussed above, the inorganic filler component can comprise, inter alia, calcium carbonate, calcium sulfate, calcium silicate, magnesium carbonate, magnesium oxide, magnesium hydroxide aluminum trihydrate, alumina, hydrated alumina, aluminum silicate, barium sulfate, barite, flyash, glass cullet, glass fiber and powder, metal powder, clay, silica or glass, fumed silica, talc, carbon black or graphite, fly ash, cement dust, feldspar, nepheline, zinc oxide, titanium dioxide, titanates, glass microspheres, chalk, and mixtures thereof. Among these, preferred fillers comprise calcium carbonate, barium sulfate, talc, silica/glass, alumina, and titanium dioxide, and mixtures thereof. More preferable fillers comprise calcium carbonate.

Likewise, the filler can be ignition resistant. Exemplary ignition resistant fillers can comprise antimony oxide, decabromobiphenyl oxide, alumina trihydrate, magnesium hydroxide, borates, and halogenated compounds. Of these ignition resistant fillers, those that comprise alumina trihydrate and magnesium hydroxide are preferred.

In a further aspect, at least a portion of the reclaimed inorganic filler composition is mixed with a thermoresponsive (e.g., a thermoplastic or a thermoset) composition to form the first carpet backing composition. In one aspect, the first carpet backing composition is comprised of a thermoresponsive polymer component wherein at least 70 weight percent of the polymer component is comprises of an homogenously branched ethylene polymer characterized as having a short chain branching distribution index (SCDBI) of greater than or equal to 50%. In a further aspect, the polymer can be a substantially linear ethylene and homogeneously branched linear ethylene polymer.

In a still further aspect, when a first backing composition comprises an adhesive comprising substantially linear ethylene polymers and homogeneously branched linear ethylene polymers, (whether present as a portion of a virgin polymer, a recycled polymer portion, or a combination thereof) the low flexural modulus of these can offer advantages in ease of carpet installation and general carpet handling. In this aspect, the substantially linear ethylene polymers, in particular, show enhanced mechanical adhesion to polypropylene when employed as an adhesive backing material, which improves the consolidation and delamination resistance of the various carpet layers and components, i.e., polypropylene fibers, fiber bundles, the primary backing material, the adhesive backing material and the secondary backing material when optionally applied. Consequently, in this exemplary aspect, exceptionally good abrasion resistance and tuft bind strength can be obtained. As one skilled in the art will appreciate, good abrasion resistance is important in commercial carpet cleaning operations as good abrasion resistance generally improves carpet durability.

Operationally, the use of the preferred substantially linear ethylene polymers and homogeneously branched linear ethylene polymers as a component of the first backing composition (i.e. the adhesive), whether present as a portion of a virgin polymer, a recycled polymer portion, or a combination thereof, can allow for the elimination of secondary backing materials and as such can result in significant manufacturing cost savings. In addition, carpets adhesively backed with the preferred polymer adhesive can provide a substantial fluid and particle barrier which enhances the hygienic properties of carpet.

In a further aspect, the preferred homogeneously branched ethylene polymers used in the present invention can be characterized by a single DSC melting peak. In this aspect, the single melting peak can be determined using a differential scanning calorimeter standardized with indium and deionized water. The exemplary method involves 5-7 mg sample sizes, a “first heat” to about 140° C. which is held for 4 minutes, a cool down at 10° C./min to −30° C. which is held for 3 minutes, and heat up at 10° C./min. to 150° C. for the “second heat”. The single melting peak is taken from the “second heat” heat flow vs. temperature curve. Total heat of fusion of the polymer is calculated from the area under the curve.

Exemplary flame retardants that can be incorporated into the adhesive backing compositions of the present invention include, without limitation, organo-phosphorous flame retardants, red phosphorous magnesium hydroxide, magnesium dihydroxide, hexabromocyclododecane, bromine containing flame retardants, brominated aromatic flame retardants, melamine cyanurate, melamine polyphosphate, melamine borate, methylol and its derivatives, silicon dioxide, calcium carbonate, resourcinol bis-(diphenyl phosphate), brominated latex base, antimony trioxide, strontium borate, strontium phosphate, monomeric N-alkoxy hindered amine (NOR HAS), triazine and its derivatives, high aspect ratio talc, phosphated esters, organically modified nanoclays and nanotubes, non-organically modified nanoclays and nanotubes, ammonium polyphosphate, polyphosphoric acid, ammonium salt, triaryl phosphates, isopropylated triphenyl phosphate, phosphate esters, magnesium hydroxide, zinc borate, bentonite (alkaline activated nanoclay and nanotubes), organoclays, aluminum trihydrate (ATH), azodicarbonamide, diazenedicarboxamide, azodicarbonic acid diamide (ADC), triaryl phosphates, isopropylated triphenyl phosphate, triazine derivatives, alkaline activated organoclay and aluminum oxide. Any desired amount of flame retardant can be used in the adhesive compositions of the instant invention and the selection of such amount will depend, in part, upon the particular flame retardant used, as well as the desired level of flame retardance to be achieved in the second generation carpet being manufactured. Such amounts can be readily determined through no more than routine experimentation.

As noted above and shown in FIG. 3, the carpet of the invention can also include an optional secondary backing material. The secondary backing material can be laminated directly to an extruded adhesive backing layer(s) while the extrudate is still molten after extrusion coating. It has been found that this technique can improve the penetration of the extrusion coating into the primary backing.

Alternatively, the secondary backing material can be laminated in a later step by reheating and/or remelting at least the outermost portion of the extruded layer or by a coextrusion coating technique using at least two dedicated extruders. Also, the secondary backing material can be laminated through some other means, such as by interposing a layer of a polymeric adhesive material between the adhesive backing material and the secondary backing material. Suitable polymeric adhesive materials include, but are not limited to, ethylene acrylic acid (EAA) copolymers, ionomers and maleic anhydride grafted polyethylene compositions.

The material for the secondary backing material can be a conventional material such as the woven polypropylene fabric sold by Propex, Inc. under the designation Action Bac®. This material is a leno weave with polypropylene monofilaments running in one direction and polypropylene yarn running in the other. A suitable example of such a material is sold by Propex, Inc. under the designation Style 3870. This material has a basis weight of about 2 OSY. In another aspect, the secondary backing material used with the present invention can be a woven polypropylene fabric with monofilaments running in both directions.

Alternatively, the secondary backing material can be a non-woven fabric. Several types are available, including, but not limited to, needle punched, spun-bond, wet-laid, melt-blown, hydraentangled, and air entangled. In one aspect, it is preferred that the secondary backing is made from a polyolefin to facilitate recycling. For example, the non-woven fabric can be spun-bond polypropylene fabric. Typically, spun-bond fabric is made from extruded and air-drawn polymer filaments which are laid down together and then point bonded, for example by a heated calendar roll. The basis weight of such a spun-bond secondary backing can be varied, preferably between 35 and 80 grams/m² (gsm) more preferably between 60 and 80 gsm. Most preferably, the basis weight is 77-83 gsm (e.g., 80 gsm). One factor favoring a higher basis weight for the spun-bond fabric is that the higher basis weight fabric is less likely to be melted when brought into contact with the molten extruded backing. In another example, it is preferred to use a needle punched non-woven secondary backing. An exemplary polypropylene non-woven needle punched secondary backing material is available from Propex, Inc. under the designation style number 9001641, having a basis weight of about 3.5 OSY.

In still another aspect, the secondary backing can be a woven needle punched polypropylene fabric such as SoftBac® manufactured by Shaw Industries, Inc. In this exemplary aspect, this material has been enhanced by having about 1.5 OSY of polypropylene fibers or polyethylene terephthalate fibers needle punched onto one side of it and has a total basis weight of about 3.5 OSY. This needle punched fabric is laminated so as to have the polypropylene fibers embedded within the adhesive backing layer. As a result, the strands of the woven polypropylene fabric are exposed. The needle punching can also help prevent scratching of an underlying substrate surface. This embodiment has been shown to have improved glue down properties as compared to an embodiment without the needle punched fibers because, without the needle punched fibers, the strands of the woven polypropylene fabric are at least partially embedded in the adhesive backing layer. As such, the surface area for gluing is reduced. It was also noted that the back of the carpet made in this embodiment was much less abrasive than that found with traditional latex backed carpet. The carpet is also more flexible than traditional latex backed carpet. Consequently, this embodiment is preferred for making areas rugs and the like. Still other materials can be used for the secondary backing. For example, if an integral pad is desired, polyurethane foam or other cushion material can be laminated to the back side of the carpet. Such backings can be used for broadloom carpet as well as for carpet tile.

In a further aspect of the present invention, a face fabric is provided. The face fabric can be either a tufted greige good, a fusion bonded material or a woven and needle punched material. Whether a tufted greige good, a fusion bonded or a woven and needle punched face fabric is used, the carpet fibers can comprise face yarns may be made from synthetic fibers such as, for example and without limitation, nylon, polyolefins, polyamides, acrylics, polyesters, polyethylene terephthalate (PET), polyethylene, polypropylene, and polytrimethylene terephthalate (PTT). Still further, the face yarns can be comprised of natural fibers such as staple rayon fibers, cellulose fibers, cotton fibers, wool fibers, viscose, and combinations thereof. In a particularly preferred aspect, the face yarns are comprised of polypropylene. In another preferred aspect, the face yarns are comprised of nylon fibers.

To prepare a greige good, a yarn is tufted, woven or needle punched into a primary backing. The tufting, weaving or needle punching can be conducted in any manner known to be suitable to one of ordinary skill in the art which will not be discussed in detail herein. To fix the yarn to the primary backing, an adhesive material is applied to the back of the fabric. In one aspect of the present invention, the adhesive material applied to the back side of the fabric is comprised of a recycled adhesive backing composition as described herein. However, in an alternative aspect, and as described in more detail below, a pre-coat layer can first be applied to the backside of the fabric in order to fix the yarn to the primary backing prior to applying the recycled adhesive backing material of the present invention.

In the present invention, a woven or a non-woven primary backing material can be used. The type of primary backing desired will depend on various factors including, but not limited to, whether broadloom carpet, carpet tile, or an area rug is being made, the desired end-use for the product (e.g., commercial or residential), the type of face yarn used and the price of the product. One example of a suitable woven primary backing is 24×18 woven primary, style no. 2218 from Propex, Inc. One example of a suitable non-woven backing material is Colbond UMT 135, manufactured by Colbond, Enka, N.C. Other types of primary backings are also suitable for use herein such as, for example, hydraentangled fibers and fiberglass.

A fusion bonded face fabric is characterized by a plurality of cut pile yarns, for example, nylon or other natural or synthetic fibrous-type material, implanted in an adhesive layer, particularly a thermoplastic, like a polyvinyl chloride layer or a hot-melt adhesive layer. Where a polyvinyl chloride plastisol layer is used, heating of the layer gels and then fuses the layer into solid form, while with hot-melt adhesive material, a melted layer is applied and subsequently cooled into solid form. The plurality of fibrous yarns are bonded to and extend upright from the adhesive base layer to form a face wear surface. Methods of making fusion bonded face goods are known and described, for example, in U.S. Pat. No. 6,089,007, the disclosure of which is incorporated in its entirety by this reference.

In another aspect, any conventional tufting or needle-punching apparatus and/or stitch patterns can be used in the carpet of the present invention. Likewise, it does not matter whether tufted yarn loops are left uncut to produce a loop pile; cut to make cut pile; or cut, partially cut and uncut to make a face texture known as tip sheared. After the yarn is tufted or needle-punched into the primary backing material, the greige good can be conventionally rolled up with the back side of the primary backing material facing outward and held until it is transferred to the backing line.

In one exemplary embodiment, the greige good can be scoured or washed before it has an adhesive backing material extruded thereon to remove or displace all or substantially all of the processing materials, such as for example oily or waxy chemicals, known as spin-finish chemicals, that remain on the yarn from the yarn manufacturing processes. It is also contemplated that the use of polyolefin waxes (rather than conventional organic and mineral oils) as processing materials would allow improved adhesive backing material performance in itself or at least minimize the use of scouring or washing methodologies.

In a further aspect, the primary backing can comprise nylon, polypropylene, polyethylene, polyester, acrylics, polyamide, fiberglass, wool, cotton, rayon, and combinations thereof. In a still aspect, the primary backing consists essentially of a polypropylene material.

As noted, according to some aspects of the invention, the greige good can optionally be coated with a pre-coat material (not shown) before the adhesive backing material is extruded thereon. The aqueous pre-coat material can, for example, be added as a dispersion or as an emulsion. In an exemplary aspect, an emulsion can be made from various polyolefin materials such as, for example and without limitation, ethylene acrylic acid (EAA), ethylene vinyl acetate (EVA), polypropylene or polyethylene (e.g., low density polyethylene (LDPE), linear low density polyethylene (LLDPE) or substantially linear ethylene polymer, or mixtures thereof). It is further contemplated that the pre-coat material can be selected from a group comprising, without limitation, an EVA hotmelt, a VAE emulsion, carboxylated styrene-butadiene (XSB) latex copolymer, a SBR latex, a BDMMA latex, an acrylic latex, an acrylic copolymer, a styrene copolymer, butadiene acrylate copolymer, a polyolefin hotmelt, polyurethane, polyolefin dispersions and/or emulsions, and any combination thereof.

When used, the pre-coat can further comprise one or more flame retardants. Exemplary flame retardants that can be incorporated into the optional pre-coat layer include, without limitation, organo-phosphorous flame retardants, red phosphorous magnesium hydroxide, magnesium dihydroxide, hexabromocyclododecane, bromine containing flame retardants, brominated aromatic flame retardants, melamine cyanurate, melamine polyphosphate, melamine borate, methylol and its derivatives, silicon dioxide, calcium carbonate, resourcinol bis-(diphenyl phosphate), brominated latex base, antimony trioxide, strontium borate, strontium phosphate, monomeric N-alkoxy hindered amine (NOR HAS), triazine and its derivatives, high aspect ratio talc, phosphated esters, organically modified nanoclays and nanotubes, non-organically modified nanoclays and nanotubes, ammonium polyphosphate, polyphosphoric acid, ammonium salt, triaryl phosphates, isopropylated triphenyl phosphate, phosphate esters, magnesium hydroxide, zinc borate, bentonite (alkaline activated nanoclay and nanotubes), organoclays, aluminum trihydrate (ATH), azodicarbonamide, diazenedicarboxamide, azodicarbonic acid diamide (ADC), triaryl phosphates, isopropylated triphenyl phosphate, triazine derivatives, alkaline activated organoclay and aluminum oxide. Any desired amount of flame retardant can be used in the precoat and the selection of such amount will depend, in part, upon the particular flame retardant used, as well as the desired level of flame retardance to be achieved in the second generation carpet being manufactured. Such amounts can be readily determined through no more than routine experimentation.

In still a further aspect, the precoat can preferably contain other ingredients. For example, a surfactant can be included to aid in keeping the polyolefin particles at least substantially dispersed. Suitable surfactants can include, for example and without limitation, nonionic, anionic, cationic and fluorosurfactants. Preferably, the surfactant is present in an amount between about 0.01 and about 5 weight percent based on the total weight of the emulsion or dispersion. More preferably, the surfactant is anionic.

In another example, the pre-coat can further comprise a thickener, a defoaming agent, and/or a dispersion enhancer. In this aspect, the thickener helps to provide a suitable viscosity to the dispersion. For example, the thickener can exemplarily comprise sodium and ammonium salts of polyacrylic acids and best present in an amount between about 0.1 and about 5 weight percent based on the total weight of the dispersion. The defoaming agent can, without limitation, be a non-silicone defoaming agent and is present in an amount between about 0.01 and about 5.0 weight percent based on the total weight of the dispersion. An exemplified dispersion enhancer can be a fumed silica that acts as a compatibilizer for the dispersion, which allows for the use of larger polyolefin particles. Preferably, the fumed silica is present at between about 0.1 and about 0.2 weight percent based on the total weight of the dispersion.

In still another aspect, the pre-coat can comprise one or more fillers. The fillers can be derived from the reclaimed inorganic filler composition discussed above. Exemplary and non-limiting fillers that can be incorporated into the adhesive backing composition of the present invention can include calcium carbonate, flyash, residual by products from the depolymerization of Nylon 6 (also referred to as ENR co-product), recycled calcium carbonate (e.g., reclaimed calcium carbonate), aluminum trihydrate, talc, nano-clay, barium sulfate, barite, barite glass fiber, glass powder, glass cullet, metal powder, alumina, hydrated alumina, clay, magnesium carbonate, calcium sulfate, silica, glass, fumed silica, carbon black, graphite, cement dust, feldspar, nepheline, magnesium oxide, zinc oxide, aluminum silicate, calcium silicate, titanium dioxide, titanates, glass microspheres, chalk, calcium oxide, and any combination thereof, in addition to the inorganic materials present in the inorganic filler composition discussed above.

The pre-coat can be applied to the carpet in various ways. For example, the dispersion can be applied directly, such as with a roll over roller applicator, or a doctor blade. Alternatively, the pre-coat can be applied indirectly, such as with a pan applicator. It is contemplated that the amount of pre coat applied and the concentration of the particles in the pre-coat can be varied depending on the desired processing and product parameters. In one example, the amount of dispersion applied and the concentration of the particles are selected so as to apply between about 4 and about 12 ounces per square yard (OSY). of carpet. In one aspect, this can be achieved by using a dispersion or emulsion containing about 50 weight percent polyolefin particles (based on the total weight of the emulsion) and applying between about 8 and about 30 OSY of the dispersion. Accordingly, it should be understood that desired application weight of the pre-coat will depend, at least in part, upon the presence and amount of inorganic fillers and/or flame retardants in the pre-coat. In an exemplary aspect, a preferred a latex precoat is the LXC 807 NA from Dow Chemicals.

After application of the pre-coat, heat can be applied to the back side of the primary backing so as to dry, melt, and/or cure the emulsion. As a result, the loops of yarn can be at least partially fixed to the primary backing. Preferably, the heat is applied by passing the product through an oven.

After treatment with the optional pre-coat emulsion of polyolefin particles, additional backing material can be applied thereto. The additional backings can be applied by various methods with the preferred method involving the use of an extruded sheet of a thermoplastic material, preferably the recycled adhesive backing composition as described above, onto which a conventional secondary backing can also be laminated. In particular, a molten thermoplastic material is preferably extruded through a die so as to make a sheet which is as wide as the carpet. The molten, extruded sheet is applied to the back side of the primary carpet backing. Since the sheet is molten, the sheet will conform to the shape of the loops of yarn and further serve to encapsulate and fix the loops in the primary backing. In aspects where a pre coat has been applied to the back side of the greige good, it will be understood that the pre-coat is disposed between the adhesive backing composition and the back side of the greige good. Alternatively, according to aspects where the optional pre coat layer is not applied, the recycled adhesive backing composition of the present invention is applied directly on the back side of the primary backing and can, itself, serve to fix the loops in the primary backing.

Exemplary extrusion coating configurations can include, without limitation, a monolayer T-type die, single-lip die coextrusion coating, dual-lip die coextrusion coating, a coat hanger die, and multiple stage extrusion coating. Preferably, the extrusion coating equipment is configured to apply a total coating weight of from about 4 to about 60 ounces/yd² (OSY), including exemplary amounts of 5, 10, 15, 20, 25, 30, 35, 40, 45, 50 and 55 ounces/yd² (OSY), and any range of coating weights derived from these values. To that end, it should be understood that the desired coating weight of the extrusion coated layers will depend, at least in part, upon the amount of any flame retardants or inorganic fillers in the extrudate.

The extrusion coating melt temperature principally depends on the particular composition of the adhesive backing composition being extruded. When using the recycled adhesive backing composition described above, comprising the preferred substantially linear polyethylene described above, the extrusion coating melt temperature can be greater than about 350° F. and, in some aspects, in the range of from 350° F. to 650° F. In another aspect, the melt temperature can be in the range of from 375° F. to 600° F. Alternatively, the melt temperature can be in the range of from 400° F. to 550° F. Still further, in aspects of the invention the melt temperature can be in the range of from 425° F. to 500° F.

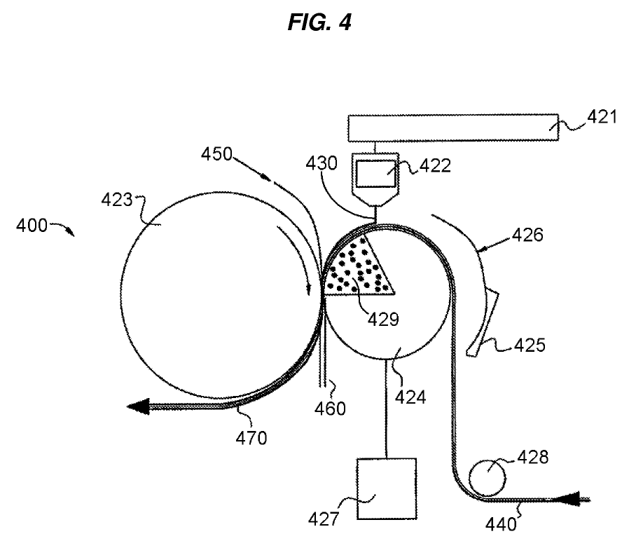

FIG. 4. shows an exemplary line 400 for applying a first backing composition (e.g., an adhesive backing composition) as described herein to the bottom surface of a greige good to provide an adhesive backed carpet 470. As shown, the line 400 includes an extruder 421 equipped with a slot die 422, a nip roll 424, a chill roll 423, an exhaust hood 426, a turn roll 428 and a pre-heater 425. As illustrated, the nip roll is preferably equipped with a vacuum slot 429 to draw a vacuum across about a portion of its circumference and is configured in communication with a vacuum pump 427. The slot die 422 is configured to dispense the recycled adhesive backing material in the form of a semi-molten or molten polymer sheet 430 onto greige good 440 with the polymer sheet 330 being oriented towards the chill roll 423 and the greige good 440 being oriented towards the optional vacuum nip roll 424. As further illustrated, an optional secondary backing material 450 can be applied onto the polymer sheet 430. The point where the nip roll 424 and the chill roll 423 are closest to one another is referred to as the nip 460.

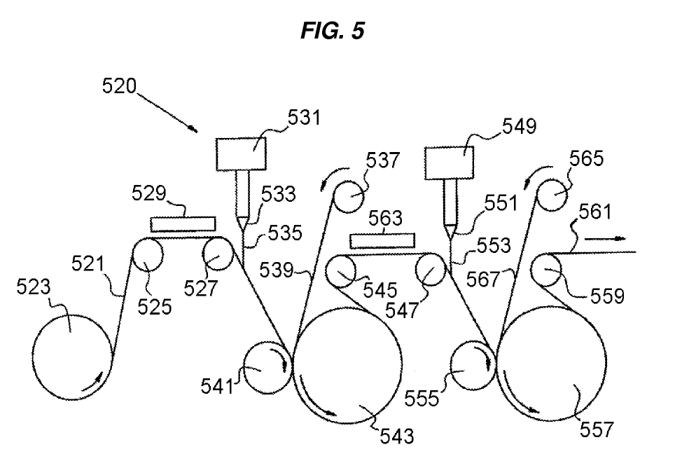

For example, FIG. 5 schematically shows an exemplary line 520 for manufacturing a carpet according to aspects of the present invention. As shown, a length of greige good 521, i.e., a plurality of carpet fibers tufted into a primary backing, is unrolled from the roll 523. The greige good 521 passes over the rollers 525 and 527 with the primary backing toward a pre-heater 529. The pre-heater, such as a convection oven or infrared panels, can be used to heat the bottom surface of the greige good before the adhesive backing material is extruded thereon to enhance the encapsulation and penetration of the yarn bundles. In addition to or as an alternative to pre-heating, the process of the invention may also employ a post-heat soaking process step to lengthen the molten time for the adhesive backing material to thereby improve the encapsulation and penetration of the yarn or fiber bundles by the adhesive backing material.

An extruder 531 is mounted so as to extrude a first sheet 535 of the first backing composition through the die 533 and onto the bottom surface of the greige good at a point between the roller 527 and the nip roll 541. The exact location at which the sheet 535 contacts the greige good can be varied depending on the line speed and the time desired for the molten polymer to rest on the greige good before passing between the nip roll 541 and the chill roll 543. In this depicted embodiment, a scrim of non-woven fiberglass 539 can be fed from roll 537 so as to contact the chill roll 543 at a point just prior to the nip roll 541. As a result, the scrim 539 that will act as a reinforcing fabric in the finished carpet is laminated to the greige good through the polymer.

The desired pressure between the nip roll 541 and the chill roll 543, measured in pounds per linear inch (PLI) can be varied depending on the force desired to push the extruded sheet. In particular, this desired pressure can be adjusted by varying the pressure within the air cylinders. Alternatively, the nip roll 541 and chill roll 543 can be operated in a gap mode whereby the spacing between the two rolls can be adjusted to a desired gap width, depending for example on the thickness of the material being passed therebetween. Also, as described in connection with FIG. 4, it may be desirable to include a vacuum slot in the nip roll. In addition, a jet of pressurized air may also be used to push the extruded sheet into the carpet backing. Still further, the size of the chill roll 543 and the length of time the carpet rolls against it can be varied depending on the level of cooling desired in the process. Preferably, the chill roll 543 is cooled by simply passing ambient or chilled water through it.

After passing over the chill roll 543, the carpet is brought over rollers 545 and 547 with the carpet pile oriented toward the rollers and the backside of the carpet, having a first layer of adhesive 535 and a scrim 539 laminated thereto oriented toward a second pre-heater 563. A second extruder 549 extrudes a second sheet of a recycled adhesive backing composition 553 through its die 551 on to the back of the scrim 539. Again the point at which the extruded sheet 553 contacts the scrim 539 can be varied as described above.

At this point, if an optional secondary backing fabric 567 is desired for the carpet composition, that fabric can be introduced from a second roll 565 similar to that shown at 537 so as to be laminated to the carpet through the extruded sheet 553 as it passes between the nip roll 555 and the chill roll 557. Subsequently, the carpet passes between the nip roll 555 and the chill roll 557. Again, the pressure applied between the two rolls 555 and 557 can be varied as required. Finally, after passing around the chill roll 557, the finished carpet 561 passes around roll 559 and is preferably passed over an embossing roll (not shown) to print a desired pattern on the back of the carpet.

As noted above, the carpet of the invention can optionally include a secondary backing material. As shown in FIG. 4 and FIG. 5, the secondary backing material is preferably laminated directly to the extruded layer(s) while the extrudate is still molten after extrusion coating to improve the penetration of the extrusion coating into the primary backing. Alternatively, the secondary backing material can be laminated in a later step by reheating and/or remelting at least the outermost portion of the extruded layer or by a coextrusion coating technique using at least two dedicated extruders. Also, the secondary backing material can be laminated through some other conventional means, such as by interposing a layer of a polymeric adhesive material between the adhesive backing material and the secondary backing material. Suitable polymeric adhesive materials include, but are not limited to, ethylene acrylic acid (EAA) copolymers, ionomers and maleic anhydride grafted polyethylene compositions. The secondary backing material can be woven or non-woven and can further be comprised of one or more polyethylene polymers such as, for example and without limitation, a low density polyethylene (LDPE), heterogeneously branched linear low density polyethylene (LLDPE), high density polyethylene (HDPE), heterogeneously branched ultra low density polyethylene (ULDPE), heterogeneously branched very low density polyethylene (VLDPE), heterogeneously branched linear low density polyethylene (LLDPE), heterogeneously branched linear very low density polyethylene (VLLDPE), a copolymer of ethylene and alpha olefin, polypropylene, a copolymer of propylene and alpha olefin, a copolymer of propylene and ethylene, ethylene vinyl acetate copolymer (EVA), ethylene methyl acrylate copolymer (EMA), grafted polyethylene polymers (e.g., a maleic anhydride extrusion grafted heterogeneously branched linear low polyethylene or a maleic anhydride extrusion grafted homogeneously branched ultra low density polyethylene), ethylene acrylic acid copolymer, ethylene ethyl acrylate copolymer, polystyrene, polyolefin, polyester, polyurethane, polybutylene, polyamide, polycarbonate, rubbers, ethylene propylene polymers, ethylene styrene polymers, styrene block copolymers, and vulcanates.

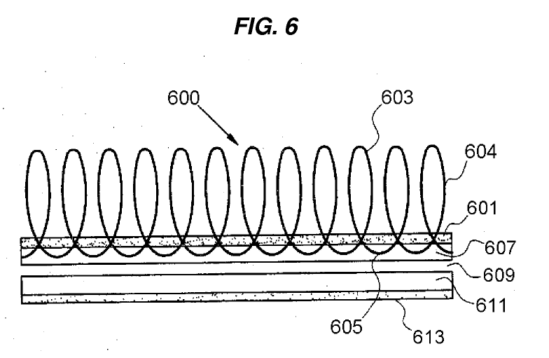

In still another aspect, the extrusion backed carpet construction and the methods described herein are particularly suited for making carpet tile. FIG. 6 shows an exemplary cross-section of a carpet tile 600 made according to the present invention. A face yarn 603 is tufted into a primary backing 601 so as to leave a carpet pile face 604 on top of the primary backing 601 and back stitches 605 below the primary backing. Applied to the back of the primary backing 601 and the back stitches 605 is a recycled adhesive composition layer 607 comprising at least one recycled polyolefin polymer component reclaimed from a process as described herein. In a preferred embodiment of carpet tile, the carpet includes from about 5 to about 200 OSY of extruded adhesive backing. More preferably, the carpet for tile includes from about 30 to about 80 OSY of extruded backing, most preferably, 50 OSY.

Preferably, the carpet tile receives its extruded adhesive backing in two passes as exemplified in FIG. 5 discussed above. The first pass applies the layer 607. Preferably this layer 607 is between about 2.5 and about 100 OSY of the extruded polymer, more preferably between about 15 and about 40 OSY, and most preferably 25 OSY. The second pass adds the layer 611. Preferably the second layer 611 is about 2.5 and about 100 OSY, more preferably between about 15 and 40 OSY, and most preferably 25 OSY.

When, for example, making carpet tile, it can again be preferable to embed a layer of reinforcing material 609 between the first and second layers of extruding backing. An important property of carpet tile is dimensional stability, i.e., the ability of the tile to maintain its size and flatness over time. The inclusion of this layer of reinforcing material has been found to enhance the dimensional stability of carpet tile made according to this preferred embodiment. Suitable reinforcing materials include dimensionally and thermally stable fabrics such as non-woven or wet-laid fiberglass scrims, as well as woven and non-woven thermoplastic fabrics (e.g. polypropylene, nylon and polyester). Most preferably, the reinforcement layer is a polypropylene non-woven fabric sold by Reemay as “Typar” with a basis weight of 3.5 OSY. Alternatively, a preferred reinforcement layer is a fiberglass scrim sold by ELK Corp. as “Ultra-Mat” with a basis weight of 1.4 OSY.

The carpet tile may also include a secondary backing fabric 613 below the second layer of extruded backing 611. Suitable materials for the secondary backing fabric include those described above.

One skilled in the art will appreciate that, notwithstanding the particular examples described above, it is contemplated that the carpet may be produced by the processes known to those of skill in the art, including but not limited to direct coating and roll metering, and knife-coating and lick-roll application, as described in D. C. Blackly, Latex and Textiles, section 19.4.2, page 361, which is incorporated herein by reference.

### EXAMPLES

To further illustrate the principles of the present invention, the following examples are put forth so as to provide those of ordinary skill in the art with a further description of how the various aspects of the invention disclosed herein can be made and/or evaluated. It should be understood however that these examples are intended to be purely exemplary of the invention and are not intended to limit the scope of the claimed invention. Where applicable, efforts have been made to ensure accuracy with respect to numbers (e.g., amounts, temperatures, etc.); however, some errors and deviations may have occurred. Unless indicated otherwise, parts are parts by weight, temperature is degrees C. or is at ambient temperature, and pressure is at or near atmospheric.

In an exemplary method, a reclaimed calcium carbonate material can be obtained from waste carpet material known as Co-Product (Residue from Carpet Recycling Process) manufactured by Shaw Industries Evergreen Nylon Recycling LLC, a joint venture of DSM and Honeywell in Augusta, Ga. As previously described herein, the so-called “Co-product” composition typically includes from 50-70% calcium carbonate, up to 45% of a thermoplastic resin mixture, and residual nylon and caprolactam. To reclaim the calcium carbonate the co-product can be conveyed to a rotary kiln to be accurately fed to the kiln using a weigh-belt feeder. The Co-product can then be combined with recycled filler to act as a dusting powder that prevents the Co-product chips from sticking together in the kiln. Co-product chips and dusting powder can then be accurately fed into the kiln. Under controlled temperature and air flow, the organic material contained in the Co-product can then be at least substantially converted to syngas and can exit through the kiln entrance to a dust chamber. Once the organic material is removed from the Co-product chips, the remaining inorganic material can then be conveyed to the exit of the kiln. If desired, the inorganic material can then be conveyed to a storage silo in preparation for further grinding and classifying. The syngas can optionally be pulled into a combustion chamber and ignited. The flame from the syngas ignition can optionally be sent to a heat recovery boiler (HRB) to produce steam for other processes. The inorganic material can then be ground to desired specifications and conveyed to silos in preparation for shipment.

Following procedures similar to the exemplary procedures described above, 39 samples of reclaimed calcium carbonate were recovered from Co-Product material obtained from the Shaw Industries Evergreen facility in Augusta, Ga. These samples were evaluated for percent moisture content, particle size, percent volatile organic content (V.O.C.) and percent sulfur content. The results of these analysis are recorded in Table 1 below. The percent moisture content was measured by heating the sample to approximately 200° C. and recording the change in weight percentage before and after heating. The particle size analysis was conducted according to a wet sieve analysis using both a 200 mesh screen and a 325 mesh screen. The wet 200 mesh analysis was conducted by first placing a 100 g sample on a 200 mesh screen and washing the material. After washing, the weight percentage of the sample remaining on the screen was recorded. Similarly, the wet 325 mesh analysis was conducted by placing a 100 g sample on a 325 mesh screen and washing the material. After washing, the weight percentage of the sample remaining on the 325 mesh screen was recorded. As illustrated by the data in Table 1, for most samples, no more than 15 g or 15 weight remained on the 200 mesh screen and no more than 30 g or 30 weight percent remained on the 325 mesh screeen. The V.O.C. content was measured by heating the sample to 550° C. and recording the change in weight percentage before and after heating.

TABLE 1

| Example # | % Moisture | +200 Wet | +325 Wet | % V.O.C. | % Sulfur |
|---|---|---|---|---|---|
| 1 | 0.100 | 5.5 | 12.7 | 0.51 | 0.83 |
| 2 | 0.160 | 6.8 | 18.2 | 0.59 | 1.07 |
| 3 | 0.200 | 6.8 | 17.6 | 0.22 | 1.11 |
| 4 | 0.060 | 8.3 | 18.3 | 0.17 | 1.42 |
| 5 | 0.130 | 7.7 | 17.7 | 0.25 | 1.48 |
| 6 | 0.090 | 9.0 | 16.6 | 0.34 | 1.31 |
| 7 | 0.160 | 7.8 | 16.9 | 0.27 | 1.55 |
| 8 | 0.180 | 9.2 | 21.3 | 0.30 | 1.77 |
| 9 | 0.160 | 12.4 | 21.6 | 0.21 | 1.37 |
| 10 | 0.180 | 12.9 | 22.1 | 0.21 | 1.40 |
| 11 | 0.110 | 11.5 | 17.5 | 0.00 | 1.74 |
| 12 | 0.160 | 16.6 | 29.4 | 0.00 | 1.69 |
| 13 | 0.110 | 5.3 | 13.1 | 0.03 | 1.51 |
| 14 | 0.160 | 5.1 | 12.6 | 0.00 | 1.74 |
| 15 | 0.070 | 5.8 | 16.0 | 0.06 | 1.64 |
| 16 | 0.130 | 13.4 | 27.7 | 0.00 | 1.59 |
| 17 | 0.170 | 9.2 | 21.1 | 0.00 | 1.42 |
| 18 | 0.190 | 7.8 | 19.2 | 0.31 | 1.60 |
| 19 | 0.150 | 8.5 | 17.9 | 0.08 | 1.86 |
| 20 | 0.100 | 7.2 | 16.6 | 0.00 | 1.57 |
| 21 | 0.190 | 9.4 | 18.8 | 0.08 | 1.41 |
| 22 | 0.120 | 7.6 | 17.6 | 0.05 | 1.40 |
| 23 | 0.090 | 6.7 | 19.3 | 0.32 | 1.58 |
| 24 | 0.150 | 9.4 | 25.6 | 0.09 | 1.52 |
| 25 | 0.060 | 12.7 | 24.8 | 0.00 | 1.67 |
| 26 | 0.060 | 11.6 | 15.3 | 0.00 | 1.33 |
| 27 | 0.040 | 14.8 | 15.2 | 0.05 | 1.53 |
| 28 | 0.110 | 14.8 | 26.8 | 0.13 | 1.91 |
| 29 | 0.090 | 14.2 | 25.2 | 0.11 | 1.53 |
| 30 | 0.060 | 13.0 | 17.0 | 0.00 | 1.67 |
| 31 | 0.060 | 11.6 | 25.6 | 0.30 | 1.39 |
| 32 | 0.070 | 15.0 | 29.5 | 0.00 | 1.82 |
| 33 | 0.170 | 14.7 | 27.2 | 0.01 | 1.77 |
| 34 | 0.080 | 26.3 | 39.3 | 0.00 | 1.72 |
| 35 | 0.150 | 10.0 | 27.0 | 0.15 | 1.54 |
| 36 | 0.120 | 9.4 | 26.0 | 0.11 | 1.45 |
| 37 | 0.100 | 8.5 | 21.3 | 0.00 | 1.78 |
| 38 | 0.120 | 6.8 | 16.4 | 0.28 | 1.45 |
| 39 | 0.070 | 7.2 | 18.0 | 0.19 | 1.48 |

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A method for reclaiming inorganic filler from waste carpeting, comprising the steps:
providing a waste carpeting composition comprising an inorganic filler component and an organic component; and
heat treating the waste carpeting composition under conditions effective to separate at least a portion of the organic component from the waste carpeting composition and to provide a reclaimed inorganic filler composition at least substantially free of the organic component.

2. The method of claim 1, wherein the inorganic filler component comprises calcium carbonate.

3. The method of claim 2, wherein the heat treating is effective to form calcium oxide from the calcium carbonate and wherein the method further comprises reforming calcium carbonate from the formed calcium oxide.

4. The method of claim 2, wherein the inorganic filler component further comprises one or more of magnesium carbonate, aluminum trihydrate, magnesium hydroxide, barium sulfate, flyash, glass cullet, barite, glass fiber and powder, metal powder, alumina, hydrated alumina, clay, magnesium carbonate, calcium sulfate, silica or glass, fumed silica, talc, carbon black or graphite, fly ash, cement dust, feldspar, nepheline, magnesium oxide, zinc oxide, aluminum silicate, calcium silicate, titanium dioxide, titanates, glass microspheres, chalk, antimony oxide, decabromobiphenyl oxide, borates, halogenated compounds, and mixtures thereof.

5. The method of claim 2, wherein the heat treating comprises heating the waste carpeting composition to a temperature in the range of from 450° C. to 825° C.

6. The method of claim 1, wherein the step of heat treating is effective to remove at least about 95-99.9% of the organic component from the waste carpeting composition.

7. The method of claim 1, wherein the organic component comprises a thermoplastic organic composition.

8. The method of claim 1, wherein the organic component comprises a thermoset organic composition.

9. The method of claim 7, wherein the organic component comprises at least one of polyethylene, polypropylene, polyurethane, ethylene vinyl acetate, polyvinyl chloride, and latex rubber, polyethylene terephalate, and polytrimethylene terephthalate.

10. The method of claim 1, wherein the waste carpeting composition further comprises nylon.

11. The method of claim 1, wherein the waste carpeting composition has a heat content of at least 2400 BTU per pound.

12. The method of claim 11, wherein the waste carpeting composition has a heat content of at least 5000 BTU per pound.

13. The method of claim 1, further comprising size reducing the reclaimed inorganic filler composition to provide reclaimed inorganic filler having a predetermined average particle size.

14. The method of claim 1, wherein the provided waste carpeting composition comprises post consumer waste carpeting.

15. The method of claim 14, wherein at least a portion of the post consumer waste carpeting is comprised of post residential carpet material.

16. The method of claim 14, wherein at least a portion of the post consumer waste carpeting is comprised of post commercial carpet material.

17. The method of claim 1, wherein the provided waste carpeting composition comprises post industrial waste carpeting.

18. The method of claim 1, wherein the waste carpet composition is substantially free of face yarns.

19. A method of manufacturing carpet, comprising the steps of:
providing a waste carpeting composition comprising an inorganic filler component and at least one organic component;
heat treating the waste carpeting composition under conditions effective to separate at least a portion of the organic component from the waste carpeting composition and to provide a reclaimed inorganic filler composition at least substantially free of the at least one organic component;
mixing at least a portion of the reclaimed inorganic filler composition with a thermoplastic or thermoset composition to form a first carpet backing composition; and
applying the first carpet backing composition to a bottom surface of a greige good comprised of a primary backing and a plurality of carpet fibers, wherein the plurality of carpet fibers penetrate a bottom surface of the primary backing and protrude therefrom a top surface of the primary backing.

20. The method of claim 19, wherein the inorganic filler component comprises calcium carbonate.

21. The method of claim 20, wherein the heat treating is effective to form calcium oxide from the calcium carbonate and wherein the method further comprises reforming calcium carbonate from the formed calcium oxide.

22. The method of claim 20, wherein the inorganic filler component further comprises one or more of magnesium carbonate, aluminum trihydrate, magnesium hydroxide, barium sulfate, flyash, glass cullet, barite, glass fiber and powder, metal powder, alumina, hydrated alumina, clay, magnesium carbonate, calcium sulfate, silica or glass, fumed silica, talc, carbon black or graphite, fly ash, cement dust, feldspar, nepheline, magnesium oxide, zinc oxide, aluminum silicate, calcium silicate, titanium dioxide, titanates, glass microspheres, chalk, antimony oxide, decabromobiphenyl oxide, borates, halogenated compounds, and mixtures thereof.

23. The method of claim 20, wherein the heat treating comprises heating the waste carpeting composition to a temperature in the range of from 450° C. to 825° C.

24. The method of claim 20, wherein the step of heat treating is effective to remove at least about 95-99.9% of the organic component from the waste carpeting composition.

25. The method of claim 20, wherein the at least one organic component comprises a thermoplastic organic composition.

26. The method of claim 25, wherein the organic component comprises at least one of polyethylene, polypropylene, polyurethane, ethylene vinyl acetate, polyvinyl chloride, and latex rubber, polyethylene terephalate, and polytrimethylene terephthalate.

27. The method of claim 20, wherein the waste carpeting composition comprises nylon.

28. The method of claim 20, wherein the waste carpeting composition has a heat content of at least 2400 BTU per pound.

29. The method of claim 28, wherein the waste carpeting composition has a heat content of at least 5000 BTU per pound.

30. The method of claim 20, further comprising size reducing the reclaimed inorganic filler composition to provide reclaimed inorganic filler having a predetermined average particle size.

31. The method of claim 20, wherein the provided waste carpeting composition comprises post consumer waste carpeting.

32. The method of claim 31, wherein at least a portion of the post consumer waste carpeting is comprised of post residential carpet material.

33. The method of claim 31, wherein at least a portion of the post consumer waste carpeting is comprised of post commercial carpet material.

34. The method of claim 20, wherein the provided waste carpeting composition comprises post industrial waste carpeting.

35. The method of claim 20, wherein the waste carpet composition is substantially free of face yarns.

36. The method of claim 20, wherein the waste carpeting composition comprising an inorganic filler component and at least one organic component.

37. The method of claim 20, wherein the first carpet backing composition is comprised of a polymer component and wherein at least 70 weight percent of the polymer component is comprised of an homogenously branched ethylene polymer characterized as having a short chain branching distribution index (SCDBI) of greater than or equal to 50%.

38. The method of claim 37, wherein the homogeneously branched ethylene polymer is further characterized as having a single differential scanning calorimetry, DSC, melting peak between −30° C. and 150° C.

39. The method of claim 37, wherein the at least one homogeneously branched ethylene polymer is homogenously branched linear ethylene polymer.

40. The method of claim 20, wherein first carpet backing composition comprises less than or equal to about 85% by weight of the reclaimed inorganic filler composition.

41. The method of claim 20, wherein the primary backing is a woven primary backing.

42. The method of claim 20, wherein the primary backing is a nonwoven primary backing.

43. The method of claim 20, wherein the plurality of carpet fibers comprises a plurality of yarns.

44. The method of claim 43, wherein the carpet fibers are selected from a group consisting of nylon, polypropylene, polyethylene, polyester, acrylics, polyamide, wool, cotton, rayon, polytrimethylene terephthalate, and combinations thereof.

45. The method of claim 20, wherein the primary backing is selected from a group consisting of nylon, polypropylene, polyethylene, polyester, acrylics, polyamide, fiberglass, wool, cotton, rayon, and combinations thereof.

46. The method of claim 20, wherein the primary backing consists essentially of a polypropylene material.

47. The method of claim 20, wherein a pre-coat material is applied to the bottom surface of the greige good prior to applying the first backing composition to the bottom surface of the greige good.

48. The method of claim 47, wherein the precoat material is selected from a group consisting of EVA hotmelt, VAE emulsion, carboxylated styrene-butadiene (XSB) latex copolymer, SBR latex, BDMMA latex, acrylic latex, acrylic copolymer, styrene copolymer, polyolefin hotmelt, polyolefin dispersion, butadiene acrylate copolymer, and combinations thereof.

49. The method of claim 20, further comprising applying a secondary backing material to the applied first backing composition to form a laminate.

50. The method of claim 49, wherein the secondary backing material is woven.

51. The method of claim 49, wherein the secondary backing material is non-woven.

52. The method of claim 49, wherein the secondary backing material is selected from a group consisting of polypropylene, polyethylene, nylon, polyethylene terephalate, and combinations thereof.

53. The method of claim 49, wherein the secondary backing material comprises at least one homogenously branched ethylene polymer characterized as having a short chain branching distribution index (SCDBI) of greater than or equal to 50%.

54. The method of claim 20, wherein the first backing composition is applied as an extrusion coating.

55. The method of claim 20, wherein the manufactured carpet is a broadloom carpet.

56. The method of claim 20, wherein the manufactured carpet is a carpet tile.

57. The reclaimed inorganic filler composition produced by the process of claim 1.
